(19) United States
(12) Patent Application Publication
(10) Pub. No.: US 2025/0011037 A1
(43) Pub. Date: Jan. 9, 2025

(54) Multiple Container System

(71) Applicant: Charmwood Chargers LLC, Coconut Grove, FL (US)

(72) Inventor: Tavish McIver Rice, Washington, DC (US)

(21) Appl. No.: 18/599,129

(22) Filed: Mar. 7, 2024

Related U.S. Application Data
(60) Provisional application No. 63/512,277, filed on Jul. 6, 2023.

(51) Int. Cl. B65D 21/02; B65D 25/04

(52) U.S. Cl. CPC B65D 21/0208; B65D 25/04; B65D 2313/04

(57) ABSTRACT

Embodiments of the present invention comprise a multiple container system. Each container of the multiple container system may have four container walls. Some containers may have pegs configured on one or more container walls that mate with corresponding holes of other containers. Some containers may have both pegs and holes so that they may be removably connected to two other containers. All containers of the multiple container system may have 4-6 magnets configured on one or more containers walls. The magnets of each container may mate with corresponding magnets of other containers. Compartments may be configured between the container walls of each container. Each container may have a lid that may be opened to expose the compartments, closed to conceal the compartments, and partially opened to expose some compartments and conceal other compartments. The lid may be held in various positions by a ball detent.

### CROSS-REFERENCE TO RELATED APPLICATIONS

This application claims priority of U.S. Provisional Patent Application 63/512,277 filed on Jul. 6, 2023, which is hereby incorporated by reference.

### BACKGROUND OF THE INVENTION

The present invention relates to containers, specifically containers used to hold pills or other small objects. Many of such containers in the art exist as compartmentalized containers with hinged lids. Many have multiple lids such that one lid exists for each compartment of the container. Many of said lids are held closed by closure features such as snap features that work well with hinged lids.

Other such containers in the art have sliding lids that slide relative to the rest of the container to expose the compartments of the container. These sliding lid containers may be desirable over the hinged lid containers in that they are easily opened and closed with one hand. However, many of the sliding lid containers in the art do not possess sophisticated closure mechanisms that allow the sliding lids to remain open, closed, or partially closed.

When using containers such as containers that hold pills or other small objects, it may be desired to removably attach multiple containers together. Each of the multiple containers may contain different objects, or may contain variations of the same object, such as pills intended to be taken at different dates and times. When removably attaching multiple containers to one another, a system is needed that allows for easy, intuitive removal and attachment of containers while maintaining a secure connection between containers.

### SUMMARY OF THE INVENTION

Embodiments of the present invention comprise a multiple container system. A first container of the multiple container system may have a first container wall, a second container wall, a third container wall, and a fourth container wall. The first container wall and third container wall may be parallel to one another. The second container wall and fourth container wall may be parallel to one another. The first container wall and third container wall may each be perpendicular to both the second container wall and the fourth container wall. The first container may have a container top and a container bottom configured opposite the container top. The container top and container bottom may be separated by a container depth.

A first hole and a second hole may be configured on the third container wall of the first container. The first hole and second hole may be separated by a hole-hole distance. A first magnet, a second magnet, a third magnet, and a fourth magnet may also be configured on the third container wall of the first container.

A second container of the multiple container system may also have a first container wall, a second container wall, a third container wall, and a fourth container wall. The first container wall and third container wall may be parallel to one another. The second container wall and fourth container wall may be parallel to one another. The first container wall and third container wall may each be perpendicular to both the second container wall and the fourth container wall. The second container may have a container top and a container bottom configured opposite the container top. The container top and container bottom may be separated by a container depth.

A first peg and a second peg may be configured on the first container wall of the second container. The first peg and second peg may be separated by a peg-peg distance. The peg-peg distance of the second container may be equal to the hole-hole distance of the first container to allow for mating between the holes and pegs as described further herein. A first magnet, a second magnet, a third magnet, and a fourth magnet may also be configured on the first container wall of the second container.

The first peg of the second container may mate with the first hole of the first container. The second peg of the second container may mate with the second hole of the first container. The first magnet of the first container may mate with the first magnet of the second container. The second magnet of the first container may mate with the second magnet of the second container. The third magnet of the first container may mate with the third magnet of the second container. The fourth magnet of the first container may mate with the fourth magnet of the second container. In this manner, the first container may be removably connected to the second container.

The first hole of the first container, the first magnet of the first container, and the second magnet of the first container may be configured in a linear pattern, which may be configured parallel to the container depth of the first container. The second hole of the first container, the third magnet of the first container, and the fourth magnet of the first container may also be configured in a linear pattern, which may be configured parallel to the container depth of the first container.

The first peg of the second container, the first magnet of the second container, and the second magnet of the second container may be configured in a linear pattern, which may be configured parallel to the container depth of the second container. The second peg of the second container, the third magnet of the second container, and the fourth magnet of the second container may also be configured in a linear pattern, which may be configured parallel to the container depth of the second container.

The first hole of the first container, the first magnet of the first container, and the second magnet of the first container may all be configured a first hole distance from the second container wall of the first container. The second hole of the first container, the third magnet of the first container, and the fourth magnet of the first container may all be configured a second hole distance from the fourth container wall of the first container. The first peg of the second container, the first magnet of the second container, and the second magnet of the second container may all be configured a first peg distance from the second container wall of the second container. The second peg of the second container, the third magnet of the second container, and the fourth magnet of the second container may all be configured a second peg distance from the fourth container wall of the second container. The first hole distance, second hole distance, first peg distance, and second peg distance may all be equal. This allows for proper mating between the various holes and pegs of the containers. This also allows for easy manufacturing of the various containers of the multiple container system, since less variation of dimensions needs to be taken into account when developing manufacturing processes.

The first magnet of the first container and the second magnet of the first container may be configured a linear magnet distance from one another. The linear magnet distance is referred to as the “vertical magnet distance” in U.S. Provisional Patent Application 63/512,277. The third magnet of the first container and the fourth magnet of the first container may also be configured the linear magnet distance from one another. The first magnet of the second container and the second magnet of the second container may also be configured the linear magnet distance from one another. The third magnet of the second container and the fourth magnet of the second container may also be configured the linear magnet distance from one another.

The first hole distance, second hole distance first peg distance, and second peg distance may all be equal, and may each be 15%-19% of the hole-hole distance, inclusive of said values. The linear magnet distance may be 12%-16% of the hole-hole distance, inclusive of said values. The linear magnet distance may be 79%-83% of the first hole distance, inclusive of said values.

These distance proportions defined herein are determined to be the optimal distance proportions to allow for the containers of the multiple container system to be easily connected while maintaining a secure connection. If the first hole distance, second hole distance, first peg distance, and second peg distance were greater than 19% of the hole-hole distance, there may be too much space between the various pegs, holes, magnets, and their closest container walls (second container wall or fourth container wall of their respective containers). Therefore, a force applied at the second container wall or fourth container wall of the containers would create a moment that the connections between the pegs, holes, and magnets may not be able to overcome. If the first hole distance, second hole distance, first peg distance, and second peg distance were less than 15% of the hole-hole distance, the hole-hole distance (and thereby the peg-peg distance) may be too great to allow for easily engaging the pegs of the second container with the holes of the first container. If the linear magnet distance were less than 12% of the hole-hole distance (or less than 79% of the first hole distance), forces applied at the container top or container bottom of the containers may create a moment that the connections between the pegs, holes, and magnets may not be able to overcome. If the linear magnet distance were greater than 16% of the hole-hole distance (or greater than 83% of the first hole distance), the linear magnet distance may be too great to allow for easily engaging the first magnet of the first container with the first magnet of the second container, the second magnet of the first container with the second magnet of the second container, the third magnet of the first container with the third magnet of the second container, and the fourth magnet of the first container with the fourth magnet of the second container.

A fifth magnet and a sixth magnet may also be configured on the third container wall of the first container. A fifth magnet and sixth magnet may also be configured on the first container wall of the second container. The fifth magnet and sixth magnet of the first container may be separated by the linear magnet distance. The fifth magnet and sixth magnet of the second container may also be separated by the linear magnet distance. When the first container is removably connected to the second container, the fifth magnet of the first container may mate with the fifth magnet of the second container, and the sixth magnet of the first container may mate with the sixth magnet of the second container.

A third container may have a first container wall, a second container wall, a third container wall, a fourth container wall, a container top, and a container bottom similar or identical to those of the first container and the second container of the multiple container system. The first container wall of the third container may have a first peg, a second peg, a first magnet, a second magnet, a third magnet, a fourth magnet, a fifth magnet, and a sixth magnet. The third container wall of the third container may have a first hole, a second hole, a first magnet, a second magnet, a third magnet, a fourth magnet, a fifth magnet, and a sixth magnet. The first peg of the third container may mate with the first hole of the first container. The second peg of the third container may mate with the second hole of the first container. The first hole of the third container may mate with the first peg of the second container. The second hole of the third container may mate with the second peg of the second container.

The first magnet of the first container wall of the third container may mate with the first magnet of the first container. The second magnet of the first container wall of the third container may mate with the second magnet of the first container. The third magnet of the first container wall of the third container may mate with the third magnet of the first container. The fourth magnet of the first container wall of the third container may mate with the fourth magnet of the first container. The fifth magnet of the first container wall of the third container may mate with the fifth magnet of the first container. The sixth magnet of the first container wall of the third container may mate with the sixth magnet of the first container.

The first magnet of the third container wall of the third container may mate with the first magnet of the second container. The second magnet of the third container wall of the third container may mate with the second magnet of the second container. The third magnet of the third container wall of the third container may mate with the third magnet of the second container. The fourth magnet of the third container wall of the third container may mate with the fourth magnet of the second container. The fifth magnet of the third container wall of the third container may mate with the fifth magnet of the second container. The sixth magnet of the third container wall of the third container may mate with the sixth magnet of the second container.

In the manner described above, the third container may be removably attached to the second container and the first container between the second container and the first container. The multiple container system may further have any number of additional containers (a fourth container, fifth container, sixth container, etc.) that may be removably attached between two other containers of the multiple container system. The additional containers may be of the same design as the third container, whereby magnets are configured on both the third container wall and the first container wall, and whereby pegs are configured on the first container wall, and whereby holes that accept pegs of other containers are configured on the third container wall. The first container of the multiple container system may only have holes and not pegs so that the first container may be used as a stand-alone container (not connected to another container) and not have pegs protruding from its container walls, since non-mated pegs protruding from a container wall may be inconvenient when said container is used as a stand-alone container.

The holes of the containers of the multiple container system may have diameters in the range of 0.05 in-0.25 in, inclusive of said values. The corresponding pegs of the containers of the multiple container system may have peg diameters that may be dimensioned to allow for a “locational clearance fit” per ANSI B4.1 when the pegs are mated with their corresponding holes. The holes and pegs may alternatively be conical. In such embodiments, the diameters at each point along lengths of the holes and pegs may be dimensioned to allow for a “locational clearance fit” per ANSI B4.1. A locational clearance fit per ANSI B4.1 was chosen as the optimal fit for a secure by user-friendly removable connection between two components made of metal or hard plastic.

The mating between the pegs and the holes may allow for a more secure engagement between containers than if only the magnets were used to removably connect the containers. The mating between the pegs and the holes may further allow for alignment of the magnets of the containers when the containers are removably attached. Aligning the pegs and holes of two containers may allow for tactile feedback that allows one to recognize when the two containers are aligned. For this reason, only two pegs and/or two holes are configured on each container. A third set of mating pegs and holes between two containers would be unnecessary since two sets of mating holes and magnets between two containers is sufficient to align all the magnets of said containers.

The number of magnets on each container of the multiple container system was chosen for the optimal combination of easy alignment between containers and a secure connection between containers. In embodiments wherein each container has 4 magnets on one container wall that mate with 4 corresponding magnets of another container, each of the 4 magnets is configured near the corner of its corresponding container wall. Therefore, there would be no “weak point” in the connection between the two containers where a moment caused by an outside force would be most effective at separating the two containers. To further eliminate the presence of “weak points” as described herein, embodiments of the multiple container system exist with fifth and sixth magnets on each container, which are configured between the first and third magnets and between the second and fourth magnets, respectively. Additional magnets (for example, a seventh magnet, eight magnet, etc.) would be unnecessary since they would not serve a purpose that the other six magnets do not serve.

In each container of the multiple container system, compartments may be configured within the four container walls. The compartments may be separated by compartment walls. The compartment walls may be configured perpendicular to the first container wall and third container wall, and parallel to the second container wall and fourth container wall. There may be one less compartment wall than compartments.

The number of compartments may be 2 or more, 4 or more, 7 or more, 9 or more, or any range between and including the values provided. Advantages of the exact number of compartments depends on the desired use of the container. For example, if the container is used to store medication, it may be desired for the container to have 7 compartments whereby each compartment may contain medication for one day of the week. In another example, if the container is used to store contact lenses, it may be desired for the container to have 2 compartments whereby one compartment contains contact lenses for a right eye and other compartment contains contact lenses for a corresponding left eye.

The container may have a container length that may extend from the second wall to the fourth wall. The container length may be 2 inches or more, 4 inches or more, 7 inches or more, 9 inches or more, or any range between and including the values provided. The desired container length may vary depending on the exact use of the container, as well as the number of compartments. For example, a container used to store medication may require a greater number of compartments and thereby have a greater container length than a container used to store contact lenses.

The container may have a container width that may extend from the first wall to the third wall. The container width may be 1 inch or more, 1.5 inches or more, 2 inches or more, or any range between and including the values provided. The desired container width may vary depending on the exact use of the container. For the purposes of calculating the container width when a lid is assembled onto the rest of the container, the container top may be the lid top. For the purposes of calculating the container width when the lid is disassembled from the rest of the container, the container top may be the portion of the container walls that the lid contacts when the lid slides along the container length. For the purposes of identifying the container top as a feature of the container, the container top may be either the lid top, the entire lid, the portion of the container walls that the lid contacts when the lid slides along the container length, the rails (described further herein), or any combination of the features listed.

The container depth of each container of the multiple container system may be 0.75 inches or more, 1 inch or more, 1.25 inches or more, or any range between and including the values provided. The desired container depth may vary depending on the exact use of the container, as well as the thickness of the lid.

The compartments may be arranged in a linear pattern along the container length whereby all the compartments are adjacent to the first container wall and third container wall, but only one compartment is adjacent to the second container wall and only one compartment is adjacent to the fourth container wall. When the lid slides along the container top, the lid may slide along the container length whereby the lid slides over the linear pattern of compartments. This allows the lid to expose multiple compartments at once. This provides an advantage over other similar containers that exist in the art since the container of the present invention allows for objects to be inserted into or removed from multiple compartments at once, rather than only one compartment at a time.

Rails may be configured at the container top. The rails may extend along the first container wall, the second container wall, and the third container wall. The rails may be connected to form one monolithic rail extending along the first container wall, the second container wall, and the third container wall. Rails may not extend along the fourth container wall so that the lid can be removed from and assembled onto the rest of the container, as well as slide along the container length. The rails may each have a rail recess and a rail overhang. The rail recesses may accept the lid to secure the lid to the container as the lid slides along the container length. The lid may have a lid perimeter recess. The lid perimeter recess may receive the rail overhangs of one or more of the rails to further secure the lid to the container as the lid slides along the container length.

A ball detent may be configured within the fourth container wall of each container. The ball detent may have a ball detent recess that may exist as a cavity within the fourth container wall. The ball detent recess may be cylindrical. The ball detent recess may alternatively be any other shape. A spring may be configured within the ball detent recess. The spring may be a linear coil spring. A ball may be configured at the end of the spring that is closest to the container top. The ball may have a protruding ball portion and a recessed ball portion. The protruding ball portion may protrude form the fourth container wall at the container top. The recessed ball portion may be recessed within the ball detent recess. The spring may expand or contract when subjected to forces, and therefore the ball may translate along the container depth. Therefore, the protruding ball portion and recessed ball portion may change depending on the movement of the ball. For example, a particular point on the ball may be within the protruding ball portion when the spring is expanded, but may be within the recessed ball portion when the spring is contracted.

A ball detent receiver may be configured within the lid bottom. The lid bottom may be parallel to the lid top. The ball detent receiver may have a channel that extends in a straight line from one end of the lid to a point within the lid bottom. Divots may be configured in a linear pattern along the channel. The number of divots may be 1 greater than the number of compartments of the container. A ball detent receiver open end may be configured at the end of the channel that meets the end of the lid. The ball detent receiver may be an indentation into the lid bottom that may be the shape of half a divot. In some embodiments, the shape of the ball detent receiver open end may be half of a concave dome.

Each of the divots may have a divot depth, which is the maximum distance that the divots extend from the lid bottom towards the lid top. The ball detent receiver open end may have a ball detent receiver open end depth, which is the maximum distance that the ball detent receiver open end extends from the lid bottom towards the lid top. The divot depth of each divot may be the same as the ball detent receiver open end depth. The channel may have a channel depth, which is the maximum distance that the channel extends from the lid bottom towards the lid top. The channel depth may be less than the divot depth of each divot. The channel depth may also be less than the ball detent receiver open end depth.

The lid may be assembled to the rest of the container by receiving the lid with the rail recesses and by receiving the rail overhangs with the lid perimeter recess. When the lid is assembled to the rest of the container, the lid bottom may be configured closer to the container bottom than the lid top, whereby the lid bottom is facing the container bottom and the lid top is facing away from the container bottom. When the lid slides relative to the container, the protruding ball portion may be configured within the channel. When the lid slides whereby a divot is configured over the protruding ball portion of the ball detent, the greater divot depth relative to the channel depth may allow the spring to extend the ball further into the divot, thus securing the lid in its current position.

The lid may be moved from said position by applying an additional force sufficient to cause a contact between the divot and the protruding ball portion that forces the ball to recess further into the fourth container wall, thereby compressing the spring and allowing the lid to slide along the container length whereby the protruding ball portion is configured within the channel and not a divot.

An open position of the lid may occur when the ball detent receiver open end is configured above the protruding ball portion. The shape and location of the ball detent receiver open end may allow the lid to be initially slid onto the rest of the container. The end of the ball detent receiver opposite the ball detent receiver open end (“the ball detent receiver closed end”) may exist as one of the divots (“the last divot”). The shape and location of the closed end of the ball detent receiver may prevent the lid from sliding off the second container wall.

Each divot of the lid bottom may correlate with a partially closed lid position and the closed lid position. For example, in embodiments wherein the lid has an open position, a closed position, and 4 partially closed positions, the lid bottom may have 5 divots. The last divot may be the divot that corresponds with the closed position.

The lid may be initially assembled onto the rest of the container by orienting the lid parallel to the container bottom whereby the lid bottom faces the container bottom and the lid top faces away from the container bottom. The ball detent receiver open end may be placed over the protruding ball portion of the ball detent. The lid may then slide whereby the lid is received by the rail recesses and the rail overhangs are received by the lid perimeter recess. The lid may slide along the container length whereby the protruding ball portion of the ball detent exits the ball detent receiver open end and enters the channel. The lid may further slide along the container length whereby the protruding ball portion enters a divot and stops the lid in a partially closed position. An additional force may be applied to the lid whereby the lid continues to slide along the container length whereby the protruding ball portion exits the divot and enters the channel. At least a portion of the additional force may be in a direction parallel to the container bottom. The ball may enter any number of divots along the channel until the ball enters the last divot, whereby the lid is configured in a closed position.

The lid may be configured solely at the container top. The lid may be shaped and configured whereby no portion of the lid extends down any of the four container walls toward the container bottom.

The lid top may have a track pad that may be made of a material with a greater coefficient of friction than the rest of the lid. The track pad may further have a greater coefficient of friction than other components of the container, such as but not limited to the rails, container walls, and compartment walls. The track pad may be flush with the lid top. The track pad may alternatively extend from the lid top. The track pad may alternatively be recessed within the lid top. A user may place their finger on the track pad and move their finger in the direction in which they wish the lid to slide in order to slide the lid relative to the rest of the container. The coefficient of friction of the track pad allows the user to complete this action without the user's finger sliding off the track pad. When the additional force is applied to the lid to whereby the protruding portion of the ball detent exists a divot and enters a channel, thereby moving the lid from a closed or partially closed position, the additional force may be applied to the track pad.

An advantage of using the ball detent and ball detent receiver together as a closure mechanism for the container as described herein may be the structural integrity of said closure mechanism. The forces applied to the closure mechanism are mostly absorbed by the spring, which, as a linear coil spring, is designed to absorb such forces. Other closure mechanisms for similar containers may exist in the art wherein forces are applied to closure mechanisms that contain stress concentrators such as snap features. These closure mechanisms with stress concentrators are prone to breaking when subjected to high forces.

The container walls, container bottom, and compartment walls may be made of metal. Said metal may be a metal that is known to be biocompatible such as but not limited to 6061-T6 aluminum, 17-4 stainless steel, 18-8 stainless steel, 300-series stainless steel, 400-series stainless steel, cobalt-chrome, or titanium. The lid may be the same material as the container walls, container bottom, and compartment walls. Alternatively, the lid may be a different material than the container walls, container bottom, and compartment walls to prevent galling when the lid slides relative to the container. In such embodiments, the lid may be made of a metal. Said metal may be a metal that is known to be biocompatible such as but not limited to 6061-T6 aluminum, 17-4 stainless steel, 18-8 stainless steel, 300-series stainless steel, 400-series stainless steel, cobalt-chrome, or titanium.

The track pad may be made of a material with a greater coefficient of friction than the lid such as but not limited to rubber, silicone, ethylene-propylene, or polyurethane. The track pad may have ridges that extend from the rest of the track pad away from the lid. The track pad may further have depressions that extend from the track pad towards the lid bottom. The ridges and depressions of the track pad may further increase the coefficient of friction of the track pad.

### BRIEF DESCRIPTION OF DRAWINGS

FIG. 1 is a top front perspective view of a first container of a multiple container system, showing a lid that is configured to expose three compartments.

FIG. 2 is a top front perspective view of the container of FIG. 1, showing the lid removed to expose three compartments and a protruding ball portion of a ball detent.

FIG. 3 is a top front perspective view of the lid of the container of FIG. 1.

FIG. 4 is a bottom view of the lid of FIG. 3.

FIG. 5 is a side cross-sectional view of the container of FIG. 1, showing an additional force being applied to the lid.

FIG. 6 is a partial side cross-sectional view of the container of FIG. 1, showing the lid being retained in a position by a ball detent.

FIG. 7 is a front cross-sectional view of the container of FIG. 1, showing the lid assembled to the rest of the container.

FIG. 8 is a top front perspective view of a second container of a multiple container system, showing a lid that is configured to expose three compartments.

FIG. 9 is a top front perspective view of a multiple container system, showing a first container and a second container.

FIG. 10 is a top front perspective view of a multiple container system, showing a first container, a second container, and a third container.

FIG. 11 is a top front perspective view of a multiple container system, showing a first container, a second container, a third container, and a fourth container.

### DETAILED DESCRIPTION OF THE INVENTION

The description provided herein describes example embodiments of the present invention and is not intended to limit the invention to any particular embodiment, feature, size, shape, design, configuration, material, or any other property. Furthermore, the figures provided herein show example embodiments of the present invention and are not intended to limit the invention to any particular embodiment, feature, size, shape, design, configuration, material, or any other property.

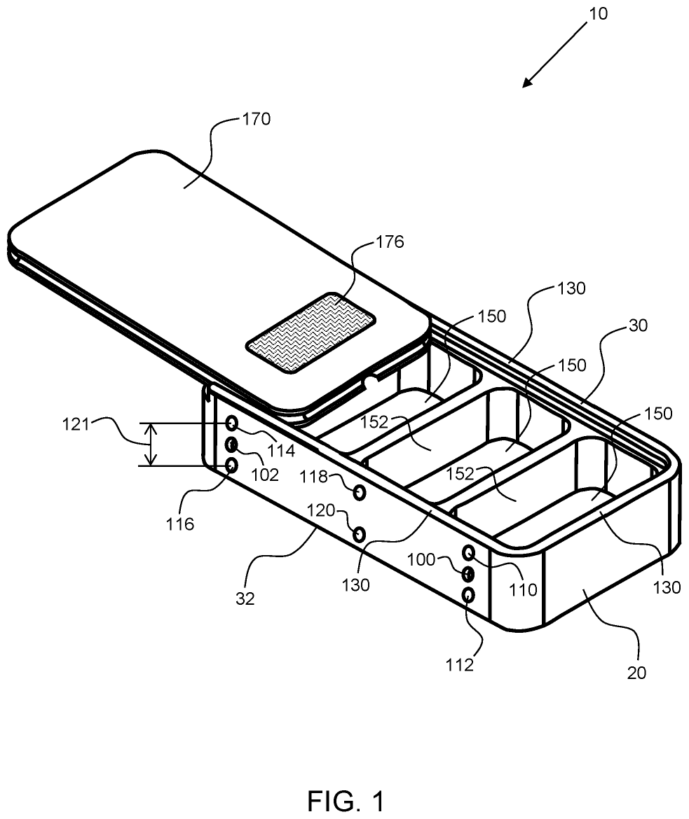

FIGS. 1-7 show various views of a first container of a multiple container system. This is not to limit the design, features, configurations, and functionality shown by these figures and included in the corresponding descriptions to only the first container of the multiple container system. The same design, features, configurations, functionality, and variations thereof may further apply to a second container, third container, fourth container, and nth container of the multiple container system.

As shown in FIG. 1, a lid 170 of a first container 20 of a multiple container system 10 is received by two rails 130 configured at a container top 30. The lid 170 is configured whereby three compartments 150 are exposed via the container top 30. A track pad 176 is configured on the lid 170. The compartments 150 are arranged in a linear pattern whereby the lid 170 may be closed to conceal one or more compartments 150. The lid 170 may also be opened or partially opened to expose one or more compartments 150. As shown in FIG. 1, the lid 170 is partially open since it fully exposes two of the three compartments 150 and partially exposes one of the three compartments 150.

A container bottom 32 is configured opposite the container top 30. A first magnet 110, second magnet 112, third magnet 114, fourth magnet 116, fifth magnet 118, and sixth magnet 120 are configured on one side of the first container 20. A first hole 100 and a second hole 102 are also configured on that side of the first container 20. The first magnet 110 and second magnet 121 are separated by a linear magnet distance 121. The third magnet 114 and fourth magnet 116 are also separated by the linear magnet distance 121. The fifth magnet 118 and sixth magnet 120 are also separated by the linear magnet distance 121.

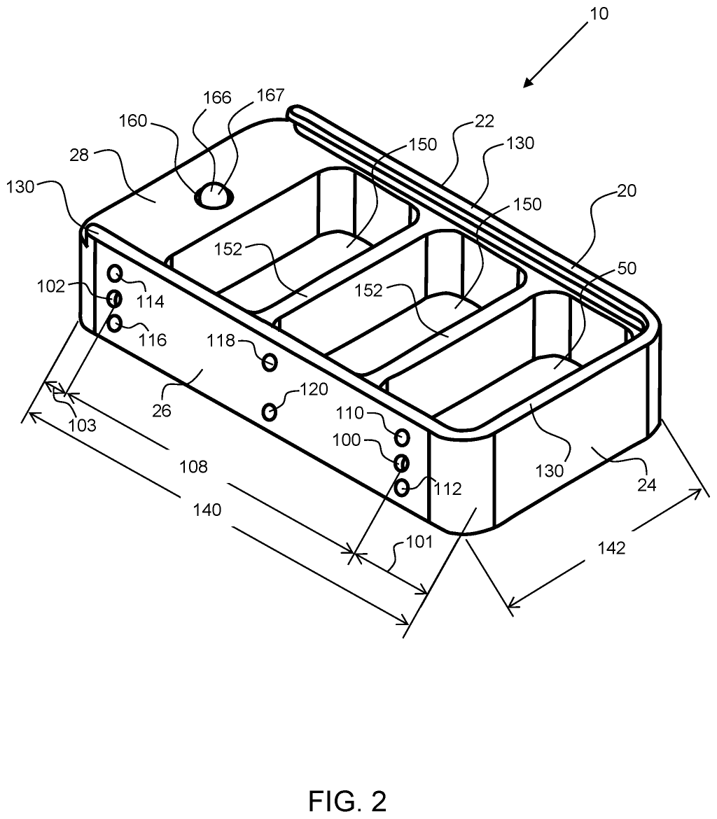

As shown in FIG. 2, the first container 20 has four container walls: a first container wall 22, a second container wall 24, a third container wall 26, and a fourth container wall 28. A container length 140 extends along the first container wall 22 and third container wall 26. A container width 142 extends along the second container wall 24 and fourth container wall 28. Rails 130 extend from the first container wall 22, second container wall 24, and third container wall 26 at the container top 30. The rails 130 are connected to form a monolithic structure with the container walls.

The fourth container wall 28 is thicker than the other three container walls. This allows a ball detent 160 to be configured within the fourth container wall 28. A protruding ball portion 167 of a ball 166 of the ball detent 160 extends from the fourth container wall 28.

The compartments 150 are configured within the four container walls. The compartments 150 are separated by compartment walls 152 that extend from the first container wall 22 to the third container wall 26. The compartment walls 152 extend perpendicular to the first container wall 22 and third container wall 26, and parallel to the second container wall 24 and fourth container wall 28. As shown in FIG. 2, the first container 20 has three compartments 150, and therefore two compartment walls 152.

The first magnet 110, second magnet 112, third magnet 114, fourth magnet 116, fifth magnet 118, sixth magnet 120, first hole 100, and second hole 102 are all configured on the third container wall 26 of the first container 20. The first magnet 110, first hole 100, and second magnet 112 are arranged in a linear pattern perpendicular to the container length 140. The third magnet 114, second hole 102, and fourth magnet 116 are also arranged in a linear pattern perpendicular to the container length 140. The fifth magnet 118 and sixth magnet 120 are also arranged in a linear pattern perpendicular to the container length 140. The first magnet 110, fifth magnet 118, and third magnet 114 are arranged in a linear pattern along the container length 140. The second magnet 114, sixth magnet 120, and fourth magnet 116 are also arranged in a linear pattern along the container length 140. Therefore, the first magnet 110, second magnet 112, third magnet 114, fourth magnet 116, fifth magnet 118, sixth magnet 120, first hole 100, and second hole 102 are arranged in a grid pattern on the third container wall 26 of the first container 20.

The first hole 100 and second hole 102 are separated by a hole-hole distance 108. The hole-hole distance 108 is parallel to the container length 140. Due to the arrangement of the various magnets of the first container 20, the first magnet 110 and third magnet 114 are also separated by the hole-hole distance 108, and the second magnet 112 and fourth magnet 116 are also separated by the hole-hole distance 108.

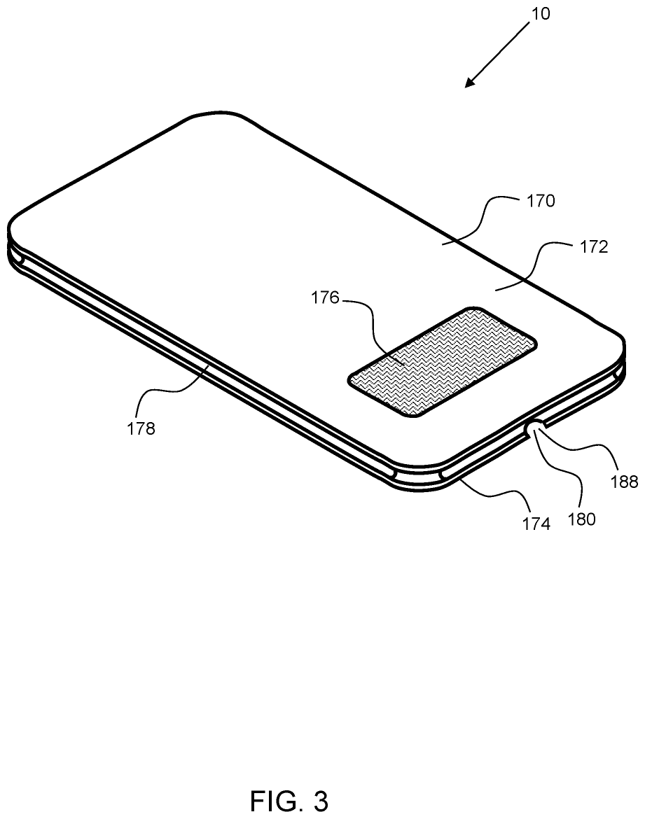

As shown in FIG. 3, the lid 170 has a lid top 172 on which the track pad 176 is configured. A lid bottom 174 is configured opposite the lid top 172. A ball detent receiver 180 is configured within the lid bottom 174. A ball detent receiver open end 188 exposes the ball detent receiver 180 at one end of the lid 170. The lid 170 has a lid perimeter recess 178 configured along the perimeter of the lid 170. The lid perimeter recess 178 may allow the lid 170 to be received by the rails of the container (not shown in FIG. 3).

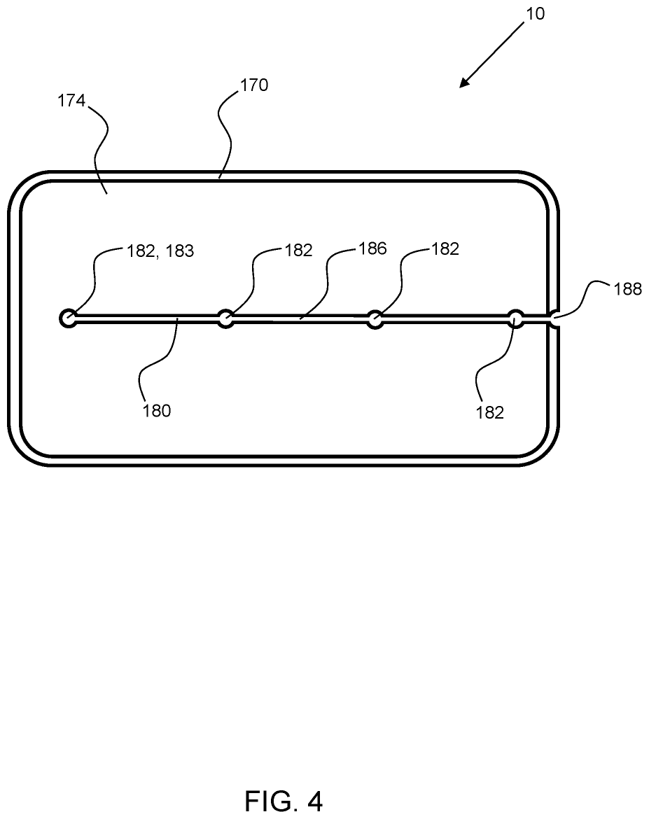

As shown in FIG. 4, a ball detent receiver 180 is configured within the lid bottom 174. Four divots 182 are configured in a linear pattern along a channel 186 of the ball detent receiver 180. The divots 182 and channel 186 are recessed into the lid 170. The number of divots 182 is four since the number of corresponding compartments (not shown in FIG. 4) of the container is three. The channel 186 starts at a ball detent receiver open end 188, which is configured at one end of the lid 170. The ball detent receiver open end 188 is the shape of half of a divot 182. The channel extends along the lid bottom 174 and ends at one of the divots 182 which is considered the “last divot” 183. The four divots 182 are evenly spaced from one another. The distance along the channel 186 between the ball detent receiver open end 188 and the divot 182 closest to the ball detent receiver open end 188 is less than the distance along the channel 186 between divots 182.

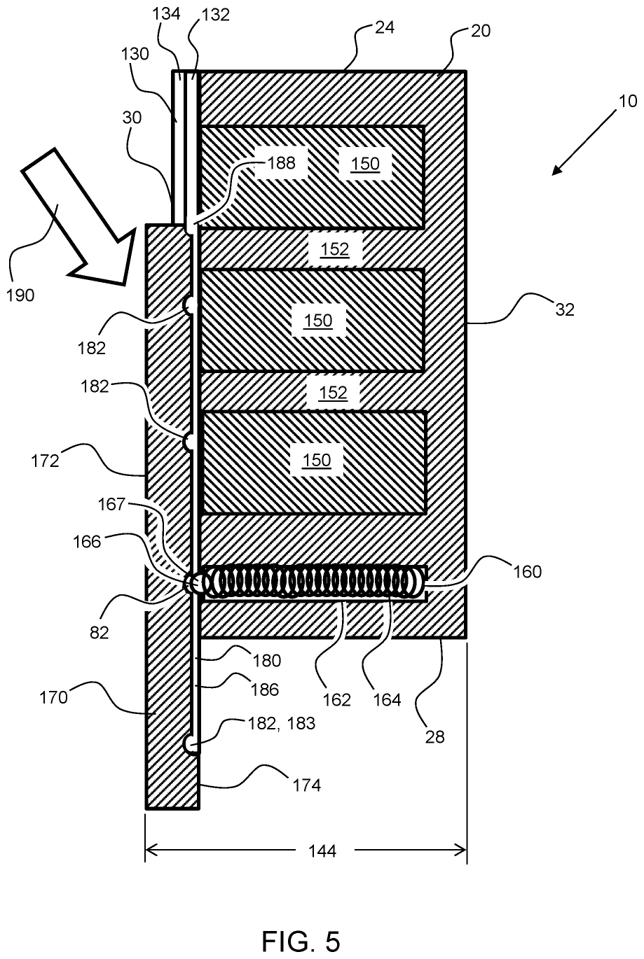

As shown in FIG. 5, the first container 20 has a container depth 144 which extends from the container bottom 32 to the container top 30. Since the lid 170 is configured on the container top 30 in FIG. 5, the container depth 144 extends from the container bottom 32 to the lid top 172.

The ball detent receiver 180 is configured within the lid bottom 174. The channel 186 has a depth that extends from the lid bottom 174 towards the lid top 172. The divots 182 and ball detent receiver open end 188 also have depths, which extend from the lid bottom 174 further towards the lid top 172 than the corresponding depth of the channel 186.

The ball detent 160 is configured within the fourth container wall 28. A spring 164 of the ball detent 160 is configured within a ball detent recess 162 of the ball detent 160. The ball 166 is configured at one end of the spring 164 and is biased towards the lid top 172 by the spring 164. The protruding ball portion 167 is thereby configured within the ball detent receiver 180 at the lid bottom 174. The lid 170 may slide relative to the container bottom 32, wherein the protruding ball portion 167 is configured within the channel 186. When the lid slides whereby a divot 182 is configured above the ball 166 of the ball detent 160, the greater depth of the divot 182 than the channel 186 allows the protruding ball portion 167 to enter the divot 182 since the ball 166 is biased towards the lid top 172 by the spring 164. The protruding ball portion 167 being configured within the divot 182 stops the lid 170 from sliding, thereby causing the lid to be configured in a stopped position. As shown in FIG. 5, the stopped position is a partially closed position since one of the compartments 150 is exposed while other compartments 150 are concealed.

The lid 170 may continue sliding (may be moved from a stopped position) if an additional force 190 is applied to the lid. At least a portion of the additional force 190 must be in the direction in which the lid is desired to slide in order to slide the lid past a divot 182. The additional force 190 must be sufficient to cause a contact between the divot 182 and the protruding ball portion 167 whereby the ball 166 recesses further into the ball detent recess 162, thereby compressing the spring 164 and allowing the lid 170 to slide relative to the container bottom 32 whereby the protruding ball portion 167 is configured within the channel 186 and not a divot 182.

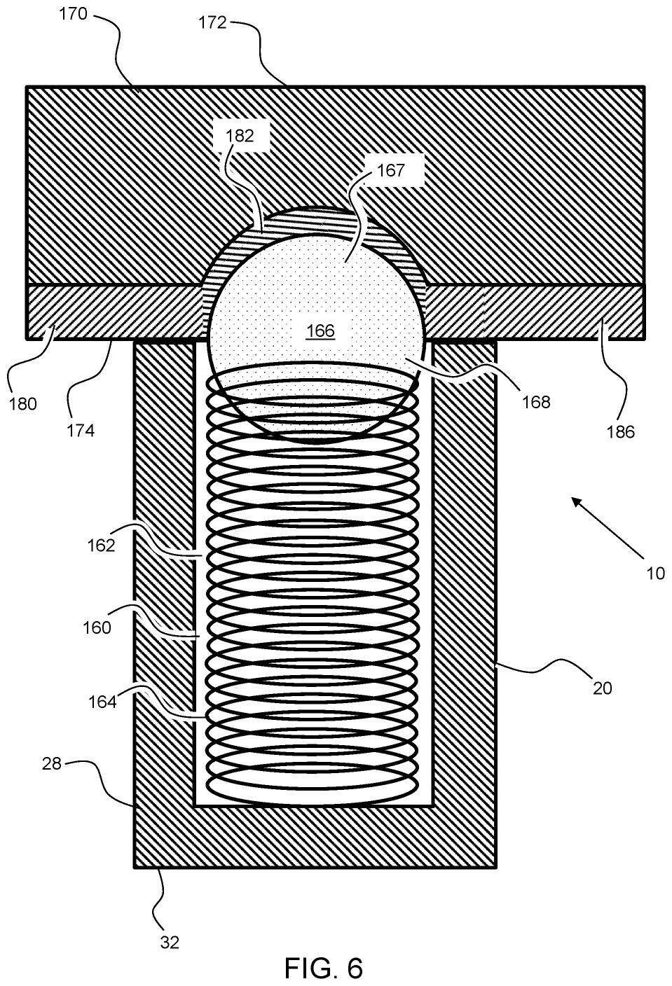

As shown in FIG. 6, the protruding ball portion 167 of the ball 166 is configured within a divot 182 of the ball detent receiver 180. A recessed ball portion 168 is configured within the ball detent recess 162 of the ball detent 160. The protruding ball portion 167 is the portion of the ball 166 that protrudes from the ball detent recess 162, and the recessed ball portion 168 is the portion of the ball 166 that is recessed within the ball detent recess 162. The protruding ball portion 167 and the recessed ball portion 168 change based on the position of the ball 166 relative to the container bottom 32. As the spring 164 causes the ball 166 to move away from the container bottom 32, more of the ball 166 protrudes from the ball detent recess 162, and therefore the protruding ball portion 167 increases and the recessed ball portion 168 decreases. When force is applied to the lid in order to move the lid from a stopped position, more of the ball 166 is recessed into the ball detent recess 162, and therefore the protruding ball portion 167 decreases and the recessed ball portion 168 increases. The spring 164 expands to cause the ball 166 to protrude further out of the ball detent recess 162. The spring 164 is compressed when the ball 166 is forced to recede further into the ball detent recess 162.

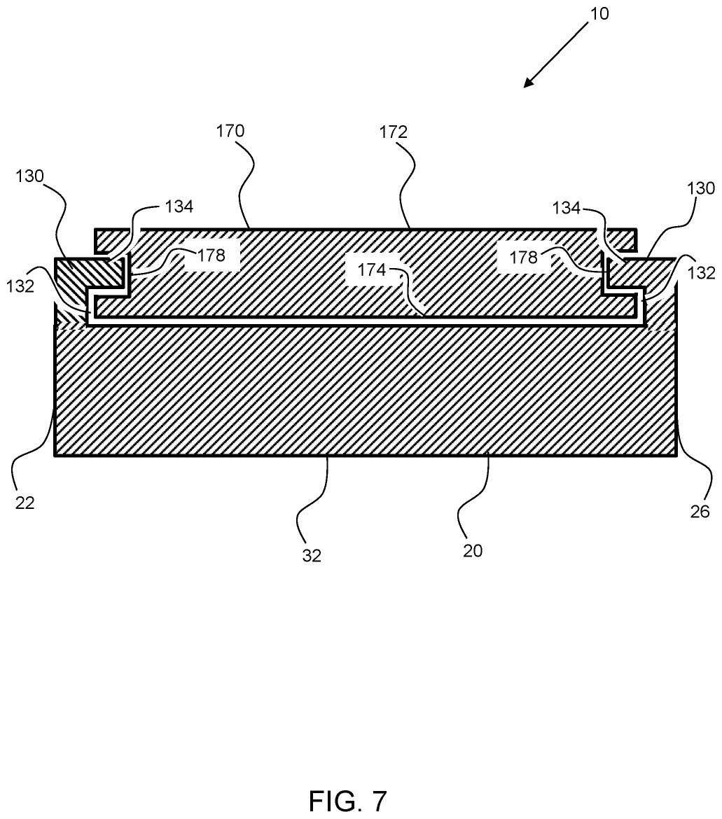

As shown in FIG. 7, the rails 130 of the first container 20 each have a rail recess 132 and a rail overhang 134. The rail overhangs 134 extend from the container walls (the first container wall 22 and third container wall 26 as shown in FIG. 7) parallel to the container bottom 32. The rail recesses 132 receive the lid bottom 174 to secure the lid 170 to the rest of the first container 20. The lid top 172 is configured the opposite side of the rail overhangs 134 than the lid bottom 174. The lid perimeter recess 178 is configured between the lid top 172 and lid bottom 174. The lid perimeter recess 178 receives the rail overhangs 134 to further secure the lid 170 to the rest of the first container 20.

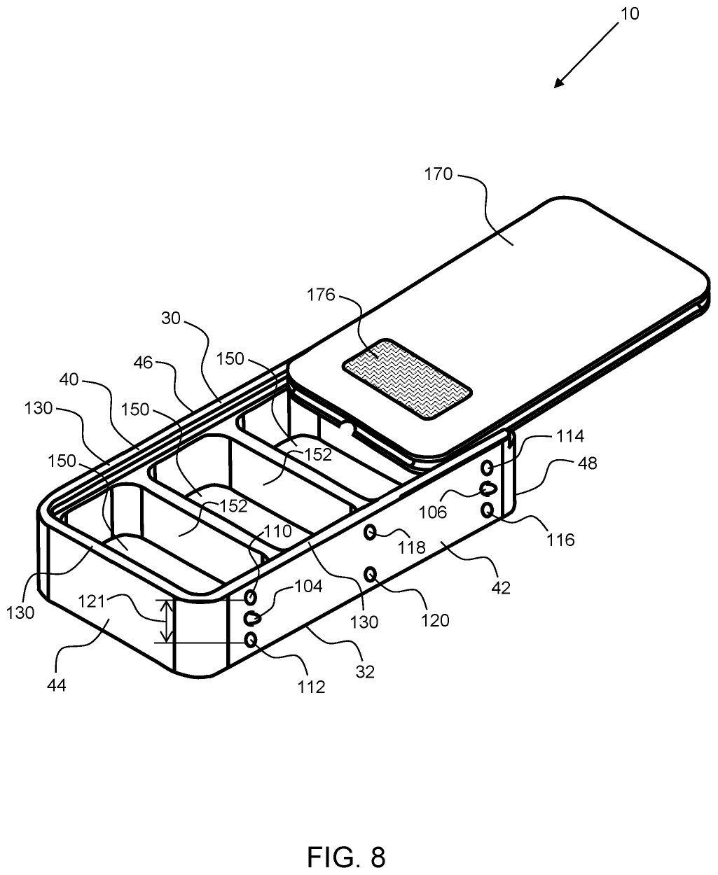

As shown in FIG. 8, a lid 170 of a second container 40 of a multiple container system 10 is received by two rails 130 configured at a container top 30. The lid 170 is configured whereby three compartments 150 are exposed via the container top 30. A track pad 176 is configured on the lid 170. The compartments 150 are arranged in a linear pattern whereby the lid 170 may be closed to conceal one or more compartments 150. The lid 170 may also be opened or partially opened to expose one or more compartments 150. As shown in FIG. 8, the lid 170 is partially open since it fully exposes two of the three compartments 150 and partially exposes one of the three compartments 150.

The second container has four container walls: a first container wall 42, a second container wall 44, and third container wall 46, and a fourth container wall 48. A container bottom 32 is configured opposite the container top 30. A first magnet 110, second magnet 112, third magnet 114, fourth magnet 116, fifth magnet 118, and sixth magnet 120 of the second container 40 are configured on the first container wall 42 of the second container 40. A first peg 104 and a second peg 106 are also configured on the first container wall 42 of the second container 40. The first magnet 110 and second magnet 121 are separated by a linear magnet distance 121. The third magnet 114 and fourth magnet 116 are also separated by the linear magnet distance 121. The fifth magnet 118 and sixth magnet 120 are also separated by the linear magnet distance 121. The first peg 104 and second peg 106 may be separated by a peg-peg distance (not shown in FIG. 8), which may be perpendicular to the linear magnet distance 121.

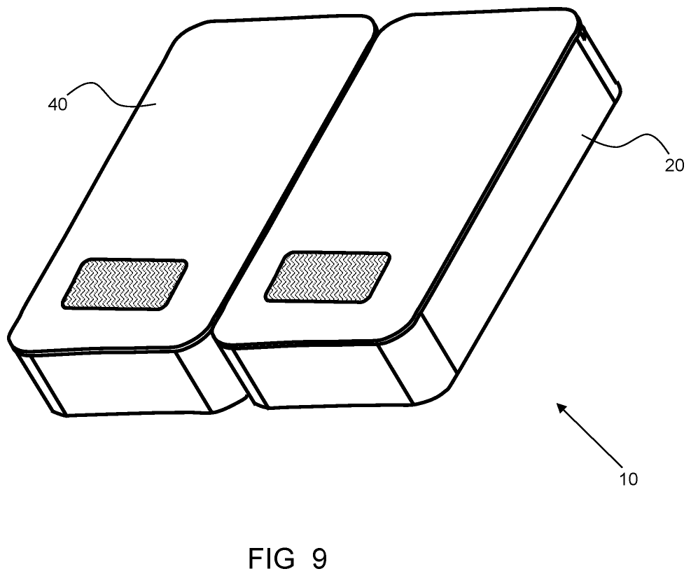

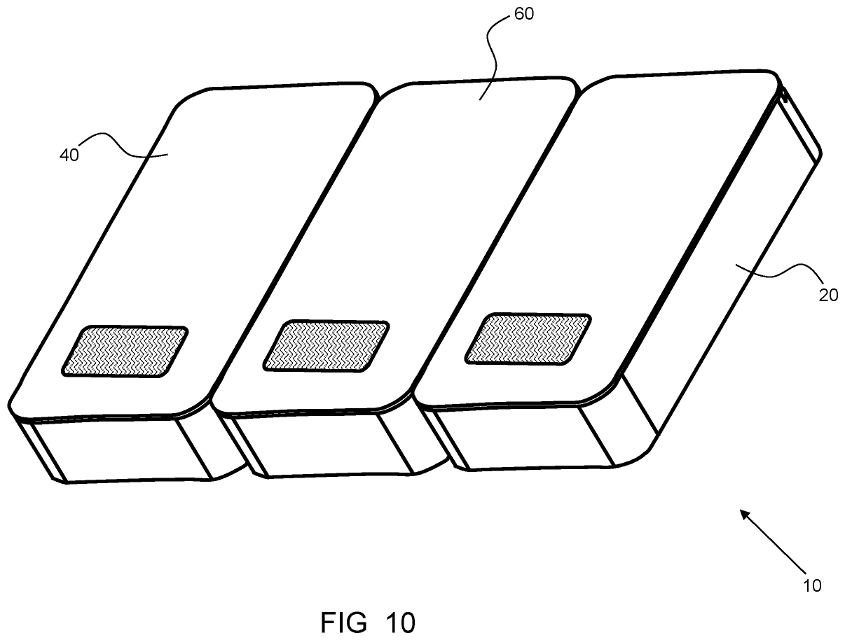

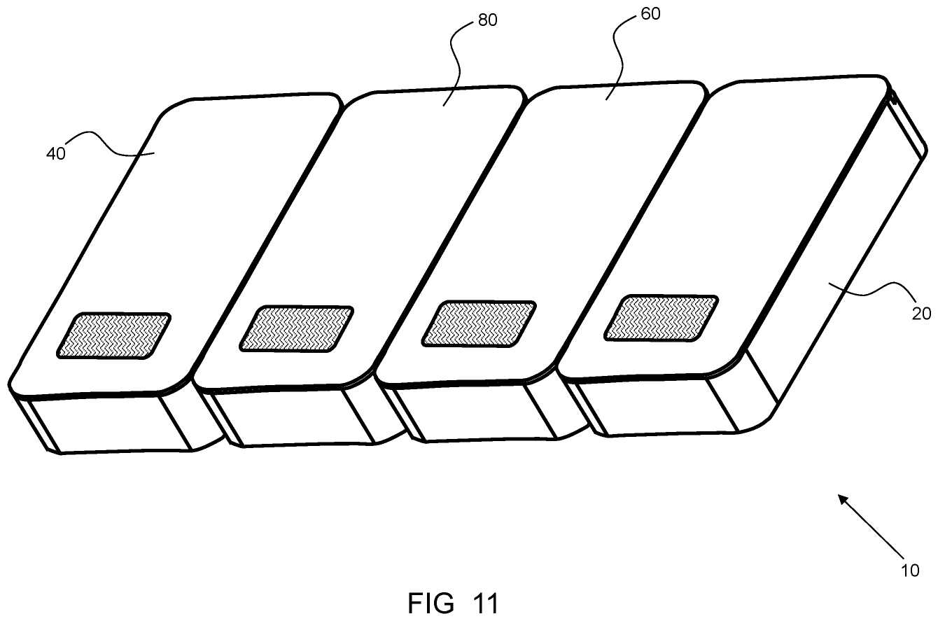

As shown in FIG. 9, a first container 20 and second container 40 are removably connected as part of a multiple container system 10. As shown in FIG. 10, a third container 60 of the multiple container system 10 is configured between the first container 20 and second container 40, and is removably connected to the first container 20 and second container 40. As shown in FIG. 11, a fourth container 80 of a multiple container system 10 is configured between the second container 40 and third container 60, and is removably connected to the second container 40 and third container 60.

1. A multiple container system comprising:
a first container comprising:
a first container wall;
a second container wall;
a third container wall comprising:
a first hole;
a second hole;
a first magnet;
a second magnet;
a third magnet;
a fourth magnet;
a fourth container wall;
a second container comprising:
a first container wall comprising:
a first peg;
a second peg;
a first magnet;
a second magnet;
a third magnet;
a fourth magnet;
a second container wall;
a third container wall; and
a fourth container wall;
wherein the first peg of the second container mates with the first hole of the first container,
wherein the second peg of the second container mates with the second hole of the first container,
wherein the first magnet of the first container mates with the first magnet of the second container,
wherein the second magnet of the first container mates with the second magnet of the second container,
wherein the third magnet of the first container mates with the third magnet of the second container,
wherein the fourth magnet of the first container mates with the fourth magnet of the second container,
whereby the first container is removably connected to the second container.

2. The system of claim 1,
wherein the first hole of the first container, the first magnet of the first container, and the second magnet of the first container are configured in a linear pattern,
wherein the second hole of the first container, the third magnet of the first container, and the fourth magnet of the first container are configured in a linear pattern,
wherein the first peg of the second container, the first magnet of the second container, and the second magnet of the second container are configured in a linear pattern,
wherein the second peg of the second container, the third magnet of the second container, and the fourth magnet of the second container are configured in a linear pattern.

3. The system of claim 2,
wherein the first hole of the first container, the first magnet of the first container, and the second magnet of the first container are all configured a first hole distance from the second container wall of the first container,
wherein the second hole of the first container, the third magnet of the first container, and the fourth magnet of the first container are all configured a second hole distance from the fourth container wall of the first container,
wherein the first hole of the first container is configured a hole-hole distance from the second hole of the first container,
wherein the first peg of the second container, the first magnet of the second container, and the second magnet of the second container are all configured a first peg distance from the second container wall of the second container,
wherein the second peg of the second container, the third magnet of the second container, and the fourth magnet of the second container are all configured a second peg distance from the fourth container wall of the second container,
wherein the first peg of the second container is configured a peg-peg distance from the second peg of the second container,
wherein the first hole distance, second hole distance, first peg distance, and second peg distance are all equal,
wherein the hole-hole distance and the peg-peg distance are equal.

4. The system of claim 3,
wherein the first magnet of the first container and the second magnet of the first container are configured a linear magnet distance from one another,
wherein the third magnet of the first container and the fourth magnet of the first container are configured the linear magnet distance from one another,
wherein the first magnet of the second container and the second magnet of the second container are configured the linear magnet distance from one another,
wherein the third magnet of the second container and the fourth magnet of the second container are configured the linear magnet distance from one another.

5. The system of claim 3,
wherein each the first hole distance, the second hole distance, the first peg distance, and the second peg distance are be 15%-19% of the hole-hole distance, inclusive of said values.

6. The system of claim 3,
wherein the linear magnet distance is 12%-16% of the hole-hole distance, inclusive of said values.

7. The system of claim 3,
Wherein the linear magnet distance is 79%-83% of the first hole distance, inclusive of said values.

8. The system of claim 1,
wherein the third container wall of the first container further comprises:
a fifth magnet; and
a sixth magnet,
and wherein the first container wall of the second container further comprises:
a fifth magnet; and
a sixth magnet,
wherein the fifth magnet of the first container mates with the fifth magnet of the second container,
wherein the sixth magnet of the first container mates with the sixth magnet of the second container,
wherein the fifth magnet of the first container and the sixth magnet of the first container are configured in a linear pattern,
wherein the fifth magnet of the second container and the sixth magnet of the second container are arranged in a linear pattern.

9. The system of claim 1, further comprising:
a third container comprising:
a first container wall comprising:
a first peg;
a second peg;
a first magnet;
a second magnet;
a third magnet;
a fourth magnet;
a second container wall;
a third container wall comprising:
a first hole;
a second hole;
a first magnet;
a second magnet;
a third magnet;
a fourth magnet; and
a fourth container wall,
wherein the first peg of the third container mates with the first hole of the first container,
wherein the second peg of the third container mates with the second hole of the first container,
wherein the first hole of the third container mates with the first peg of the second container,
wherein the second hole of the third container mates with the second peg of the second container,
wherein the first magnet of the first container wall of the third container mates with the first magnet of the first container,
wherein the second magnet of the first container wall of the third container mates with the second magnet of the first container,
wherein the third magnet of the first container wall of the third container mates with the third magnet of the first container,
wherein the fourth magnet of the first container wall of the third container mates with the fourth magnet of the first container,
wherein the first magnet of the third container wall of the third container mates with the first magnet of the second container,
wherein the second magnet of the third container wall of the third container mates with the second magnet of the second container,
wherein the third magnet of the third container wall of the third container mates with the third magnet of the second container,
wherein the fourth magnet of the third container wall of the third container mates with the fourth magnet of the second container,
whereby the third container is removably connected to both the first container and the second container,
wherein the third container is configured between the first container and the second container.

10. The system of claim 9, further comprising:
a fourth container comprising:
a first container wall comprising:
a first peg;
a second peg;
a first magnet;
a second magnet;
a third magnet;
a fourth magnet;
a second container wall;
a third container wall comprising:
a first hole;
a second hole;
a first magnet;
a second magnet;
a third magnet;
a fourth magnet; and
a fourth container wall,
wherein the first peg of the fourth container mates with the first hole of the third container,
wherein the second peg of the fourth container mates with the second hole of the third container,
wherein the first hole of the fourth container mates with the first peg of the second container,
wherein the second hole of the fourth container mates with the second peg of the second container,
wherein the first magnet of the first container wall of the fourth container mates with the first magnet of the third container wall of the third container,
wherein the second magnet of the first container wall of the fourth container mates with the second magnet of the third container wall of the third container,
wherein the third magnet of the first container wall of the fourth container mates with the third magnet of the first container wall of the third container,
wherein the fourth magnet of the first container wall of the fourth container mates with the fourth magnet of the first container wall of the third container,
wherein the first magnet of the third container wall of the fourth container mates with the first magnet of the second container,
wherein the second magnet of the third container wall of the fourth container mates with the second magnet of the second container,
wherein the third magnet of the third container wall of the fourth container mates with the third magnet of the second container,
wherein the fourth magnet of the third container wall of the fourth container mates with the fourth magnet of the second container,
whereby the fourth container is removably connected to both the third container and the second container,
wherein the third container is configured between the third container and the second container.

11. A multiple container system comprising:
a first container and a second container, each comprising:
a first container wall;
a second container wall configured perpendicular to the first container wall;
a third container wall configured parallel to the first container wall;
a fourth container wall configured perpendicular to the first container wall;
a container top;
rails configured at the container top and extending along the first container wall, second container wall, and third container wall, the rails each having a rail recess and a rail overhang;
a container bottom configured opposite the container top;
a container length extending from the second container wall to the fourth container wall;
compartments configured within the container, wherein the compartments are configured linearly along the container length;
compartment walls configured parallel to the second container wall and fourth container wall, the number of compartment walls being 1 less than the number of compartments;
a ball detent configured within the fourth container wall, the ball detent comprising:
a ball detent recess;
a spring configured within the ball detent recess;
a ball comprising:
a protruding ball portion protruding from the fourth container wall at the container top;
a recessed ball portion configured inside the ball detent recess;
a lid comprising:
a lid top;
a lid bottom configured opposite the lid top;
a ball detent receiver configured at the lid bottom, the ball detent receiver comprising:
a channel;
divots configured linearly along the channel, the number of divots being 1 greater than the number of compartments; and
a ball detent receiver open end,
wherein the lid is received by the rail recesses of at least two of the rails,
whereby the lid slides along the container length parallel to the container bottom,
wherein the protruding ball portion of the ball is received into the ball detent receiver by the ball detent receiver open end,
wherein the protruding ball portion is configured within the channel as the lid slides along the container length,
wherein the protruding ball portion is configured within the channel as the lid slides along the container length,
wherein the protruding ball portion enters at least one divot, whereby the lid stops sliding along the container length unless an additional force is applied to the lid,
whereby at least one of the containers is exposed via the container top,
wherein multiple containers are exposed as the lid continues to slide along the container length,
wherein the third wall of first container has at least one hole and at least one magnet,
wherein the first wall of the second container has at least one peg and at least one magnet,
wherein the at least one peg of the second container mates with the at least one hole of the first container,
wherein the at least one magnet of the second container mates with the at least one magnet of the first container,
whereby the first container is removably connected to the second container.

12. The system of claim 11,
wherein the at least one hole of the first container is a first hole and a second hole,
wherein the at least one peg of the second container is a first peg and a second peg,
wherein the first peg mates with the first hole and wherein the second peg mates with the second hole,
wherein the first hole is configured a first hole distance from the second container wall of the first container,
wherein the second hole is configured a second hole distance from the fourth container wall of the first container,
wherein the first peg is configured a first peg distance from the second container wall of the second container,
wherein the second peg is configured a second peg distance from the fourth container wall of the second container,
wherein the first hole distance, the second hole distance, the first peg distance, and the second peg distance are all equal.

13. The system of claim 12,
wherein the first hole and the second hole are configured a hole-hole distance from one another,
wherein the first peg and the second peg are configured a peg-peg distance from one another,
wherein the hole-hole distance and the peg-peg distance are equal.

14. The system of claim 13,
wherein each the first hole distance, the second hole distance, the first peg distance, and the second peg distance are be 15%-19% of the hole-hole distance, inclusive of said values.

15. The system of claim 11, further comprising:
a third container comprising:
a first container wall comprising:
at least one peg;
at least one magnet;
a second container wall;
a third container wall comprising:
at least one hole;
at least one magnet; and
a fourth container wall,
wherein the at least one peg of the third container mates with the at least one hole of the first container,
wherein the at least one hole of the third container mates with the at least one peg of the second container,
wherein the at least one magnet of the first container wall of the third container mates with the at least one magnet of the third container wall of the first container,
wherein the at least one magnet of the third container wall of the third container mates with the at least one magnet of the first container wall of the second container,
whereby the third container is removably connected to both the first container and the second container,
wherein the third container is configured between the first container and the second container.

16. The system of claim 15, further comprising:
a fourth container comprising:
a first container wall comprising:
at least one peg;
at least one magnet;
a second container wall;
a third container wall comprising:
at least one hole;
at least one magnet; and
a fourth container wall,
wherein the at least one peg of the fourth container mates with the at least one hole of the third container,
wherein the at least one hole of the fourth container mates with the at least one peg of the second container,
wherein the at least one magnet of the first container wall of the fourth container mates with the at least one magnet of the third container wall of the third container,
wherein the at least one magnet of the third container wall of the fourth container mates with the at least one magnet of the first container wall of the second container,
whereby the fourth container is removably connected to both the third container and the second container,
wherein the fourth container is configured between the third container and the second container.

17. The system of claim 16, wherein the third container and the fourth container both further comprise:
a container top;
rails configured at the container top and extending along the first container wall, second container wall, and third container wall, the rails each having a rail recess and a rail overhang;
a container bottom configured opposite the container top;
a container length extending from the second container wall to the fourth container wall;
compartments configured within the container, wherein the compartments are configured linearly along the container length;
compartment walls configured parallel to the second container wall and fourth container wall, the number of compartment walls being 1 less than the number of compartments;
a ball detent configured within the fourth container wall, the ball detent comprising:
a ball detent recess;
a spring configured within the ball detent recess;
a ball comprising:
a protruding ball portion protruding from the fourth container wall at the container top;
a recessed ball portion configured inside the ball detent recess;
a lid comprising:
a lid top;
a lid bottom configured opposite the lid top;
a ball detent receiver configured at the lid bottom, the ball detent receiver comprising:
a channel;
divots configured linearly along the channel, the number of divots being 1 greater than the number of compartments; and
a ball detent receiver open end,
wherein the lid is received by the rail recesses of at least two of the rails,
whereby the lid slides along the container length parallel to the container bottom,
wherein the protruding ball portion of the ball is received into the ball detent receiver by the ball detent receiver open end,
wherein the protruding ball portion is configured within the channel as the lid slides along the container length,
wherein the protruding ball portion is configured within the channel as the lid slides along the container length,
wherein the protruding ball portion enters at least one divot, whereby the lid stops sliding along the container length unless an additional force is applied to the lid,
whereby at least one of the containers is exposed via the container top,
wherein multiple containers are exposed as the lid continues to slide along the container length.

18. The system of claim 11, wherein the first container and the second container both comprise a track pad configured at the lid top,
wherein the track pad has a coefficient of friction that is greater than corresponding coefficients of friction of the other portions of the container.

19. The system of claim 17, wherein the third container and the fourth container both comprise a track pad configured at the lid top,
wherein the track pad has a coefficient of friction that is greater than corresponding coefficients of friction of the other portions of the container.

20. The system of claim 17, wherein in each the first container, the second container, the third container, and the fourth container, the ball detent receiver comprises a las divot configured at an opposite end of the ball detent receiver than the ball detent receiver open end,
wherein when the lid slides along the container length whereby the protruding ball portion enters the last divot, the lid is configured in a closed position.
